(19) United States
(12) Patent Application Publication
(10) Pub. No.: US 2016/0152268 A1
(43) Pub. Date: Jun. 2, 2016

(54) APPARATUS AND METHOD OF CONTROLLING AUTOMATIC TAKING-OUT OF VEHICLE

(71) Applicant: HYUNDAI MOBIS Co., Ltd, Seoul (KR)

(72) Inventors: Hyun Wook BAEK, Yongin-si (KR); Ik Su SHIN, Yongin-si (KR)

(73) Assignee: HYUNDAI MOBIS Co., Ltd, Seoul (KR)

(21) Appl. No.: 14/951,644

(22) Filed: Nov. 25, 2015

(30) Foreign Application Priority Data
Dec. 1, 2014 (KR) 10-2014-0169669

(51) Int. Cl. B62D 15/02

(52) U.S. Cl. CPC B62D 15/027

(57) ABSTRACT

Disclosed are an apparatus and a method of controlling automatic taking-out of a vehicle. The apparatus for controlling automatic taking-out of a vehicle includes: a vehicle taking-out space recognizing unit configured to detect obstacles at front and rear sides of a vehicle and a curb at a lateral side of the vehicle to recognize a vehicle taking-out space; an interface unit configured to display the recognized vehicle taking-out space, the recognized obstacles at the front and rear sides of the vehicle, and the vehicle as images, and receive a vehicle taking-out movement trace from a user; a vehicle taking-out route calculating unit configured to sequentially calculate turning routes for parallelly taking out the vehicle based on the recognized vehicle taking-out space and the user input; and a controller configured to control steering for parallelly taking out the vehicle according to the calculated sequential turning routes.

### CROSS-REFERENCE TO RELATED APPLICATIONS

This application claims priority under 35 U.S.C. §119 to Korean Patent Application No. 10-2014-0169669, filed on Dec. 1, 2014, in the Korean Intellectual Property Office, the disclosure of which is incorporated herein by reference in its entirety.

### TECHNICAL FIELD

The present invention relates to an apparatus and a method of controlling automatic taking-out of a vehicle, and particularly, to an apparatus and a method of controlling automatic taking-out of a vehicle, which calculate a vehicle movement trace up to a vehicle taking-out end position desired by a user by using a drag-and-drop using a touch pad, thereby enabling a user to take out a vehicle in various environments and prepare in case of danger of an obstacle collision.

### BACKGROUND

Recently, a vehicle, such as an automobile, becomes an essential item of modern people, in this respect, a new vehicle has been sharply released and operated, but incur various social problems, such as traffic congestion and a parking problem.

Particularly, a parking problem is severe, so that when the number of vehicles is increased in a limited region, city, and country, a parking space, in which a vehicle may be parked, is inevitably decreased, and in order to solve a lack of parking space, a parking section, which is divided so as to park one vehicle, becomes gradually small.

When several vehicles are parked together in a parking space, in which there is no parking section, an interval between the vehicles is inevitably small, and in this case, there is a problem in that a driver needs to check a surrounding obstacle visually while directly driving a vehicle in order to park the vehicle in a narrow parking space or take out the vehicle from a narrow parking space.

Typically, when a beginning driver, a woman driver, or the elderly, who are inexperienced to park, parks a vehicle at a narrow space, he/she cannot accurately predict an interval with already parked vehicles at both sides or front and back sides of the space for parking, so that he/she reverses or drives forwardly the vehicle several times to park the vehicle.

In general, in parallel parking, other parked vehicles are located at front and back sides of a corresponding vehicle, and a curb is positioned at a lateral side of the corresponding vehicle.

Recently, when a driver takes out a corresponding parked vehicle from the parking space as described above, a distance to a curb is measured by using sensors installed at a lateral part of the corresponding vehicle, parking state information about the corresponding parked vehicle is obtained, and then the vehicle is taken out through a separate automatic vehicle taking-out system.

Particularly, a method of controlling a movement trace and a steering angle of a vehicle through a drag-and-drop using a touch pad has been suggested.

However, when it is desired to control taking-out a parked vehicle through a drag-and-drop in the related art, a movement route of the vehicle is not considered, and a movement trace of the vehicle is calculated by using only an initial position of the vehicle and a position of a touch end point, so that it is impossible to support taking-out of the vehicle to a point desired by a user.

### SUMMARY

An exemplary embodiment of the present invention provides an apparatus for controlling automatic taking-out of a vehicle, the apparatus including: a vehicle taking-out space recognizing unit configured to detect obstacles at front and rear sides of a vehicle and a curb at a lateral side of the vehicle to recognize a vehicle taking-out space; an interface unit configured to display the recognized vehicle taking-out space, the recognized obstacles at the front and rear sides of the vehicle, and the vehicle as images, and receive a vehicle taking-out movement trace from a user; a vehicle taking-out route calculating unit configured to sequentially calculate turning routes for parallelly taking out a vehicle based on the recognized vehicle taking-out space and the user input; and a controller configured to control steering for parallelly taking out the vehicle according to the calculated sequential turning routes.

The vehicle taking-out space recognizing unit may measure distance values with the front obstacle to measure a relative first position value with respect to the front obstacle, measure distance values with the rear obstacle to measure a relative second position value with respect to the rear obstacle, and measure distance values with the curb to measure a relative third position value with respect to the curb.

The vehicle taking-out route calculating unit may calculate a first turning route, a second turning route, and an additional route for parallelly taking out the vehicle based on a relative position with respect to a corner of the front obstacle recognized by the vehicle taking-out space recognizing unit and a user input.

The vehicle taking-out route calculating unit may calculate a vehicle taking-out start position for each turning route and a first stop position, from which the vehicle moves to a vehicle taking-out end position based on the user input within the shortest distance when calculating each of the first turning route, the second turning route, and the additional route.

The vehicle taking-out route calculating unit may calculate a second stop position satisfying a condition that one side end of a center line of a rear wheel of the vehicle meets a y-axis of a corner of the front obstacle.

The vehicle taking-out route calculating unit may calculate the additional route from the second stop position to a vehicle taking-out end position, at which a touch of the user input is ended, based on the user input.

The vehicle taking-out route calculating unit calculates a first turning angle, a vehicle taking-out start position, and a first stop position satisfying a collision avoidance condition with respect to a corner of the front obstacle while maximally steering the vehicle to calculate a first turning route, and calculates a second turning angle and a second stop position satisfying a condition that one side end of a center line of a rear wheel of the vehicle meets a y-axis of a corner of the front obstacle to calculate a second turning route.

The controller controls parallel taking-out vehicle state information to be output through the interface unit by at least one manner of a video, an audio, and a character.

Another exemplary embodiment of the present invention provides a method of controlling automatic taking-out of a vehicle, the method including: detecting obstacles at front and rear sides of a vehicle and a curb at a lateral side of the vehicle to recognize a vehicle taking-out space; displaying the recognized vehicle taking-out space, the recognized obstacles at the front and rear sides of the vehicle, and the vehicle as images, and receiving a vehicle taking-out movement trace from a user; sequentially calculating turning routes for parallelly taking out the vehicle based on the recognized vehicle taking-out space and the user input; and controlling steering for parallelly taking out the vehicle according to the calculated sequential turning routes.

The recognizing of the vehicle taking-out space may include: measuring distance values with the front obstacle to measure a relative first position value with respect to the front obstacle; measuring distance values with the rear obstacle to measure a relative second position value with respect to the rear obstacle; and measuring distance values with the curb to measure a relative third position value with respect to the curb.

The calculating of the turning routes may include: calculating a first turning angle, a vehicle taking-out start position, and a first stop position satisfying a collision avoidance condition with respect to a corner of the front obstacle while maximally steering the vehicle to calculate a first turning route; and calculating a second turning angle and a second stop position satisfying a condition that one side end of a center line of a rear wheel of the vehicle meets a y-axis of a corner of the front obstacle to calculate a second turning route.

The calculating of the turning routes may further include calculating the additional route from the second stop position to a vehicle taking-out end position, at which a touch of the user input is ended, based on the user input.

The controlling of the steering may include: forwardly turning, by the vehicle, from the vehicle taking-out start position to the first stop position at the first turning angle according to the first turning route; forwardly turning, by the vehicle, from the first stop position to the second stop position at the second turning angle according to the second turning route; and reversing, by the vehicle, from the second stop position to the vehicle taking-out end position according to the additional route.

The method may further include outputting vehicle parallel taking-out state information to an output device through at least one manner of a video, audio, and a character while parallelly taking out the vehicle.

Other features and aspects will be apparent from the following detailed description, the drawings, and the claims.

### BRIEF DESCRIPTION OF THE DRAWINGS

FIG. 1 is a block diagram for describing a configuration of an apparatus for controlling automatic taking-out of a vehicle according to an exemplary embodiment of the present invention.

FIG. 2 is a flowchart for describing a method of controlling automatic taking-out of a vehicle according to an exemplary embodiment of the present invention.

FIG. 3 is a diagram for describing a method of recognizing a vehicle taking-out space when controlling the automatic taking-out of the vehicle according to the exemplary embodiment of the present invention.

FIG. 4 is a diagram illustrating an example of an interface image output to a user when controlling the automatic taking-out of the vehicle according to the exemplary embodiment of the present invention.

FIGS. 5 to 7 are diagrams for describing a method of calculating a turning route for taking out a vehicle when controlling the automatic taking-out of the vehicle according to the exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Advantages and features of the present invention and methods of achieving the advantages and features will be clear with reference to exemplary embodiments described in detail below together with the accompanying drawings. However, the present invention is not limited to the exemplary embodiments set forth below, and may be embodied in various other forms. The present exemplary embodiments are for rendering the description of the present invention complete and are set forth to provide a complete understanding of the scope of the invention to a person with ordinary skill in the technical field to which the present invention pertains, and the present invention will only be defined by the scope of the claims. Like reference numerals indicate like elements throughout the specification.

In the following description of the exemplary embodiment, a detailed description of known configurations or functions incorporated herein will be omitted when it is determined that the detailed description may make the subject matter of the present disclosure unclear. The terms which will be described below are terms defined in consideration of the functions in the present invention, and may be different according to users, intentions of the users, or customs. Therefore, the definitions should be made based on the entire contents of the present specification.

Hereinafter, an apparatus and a method of controlling automatic taking-out of a vehicle according to the present invention will be described in detail.

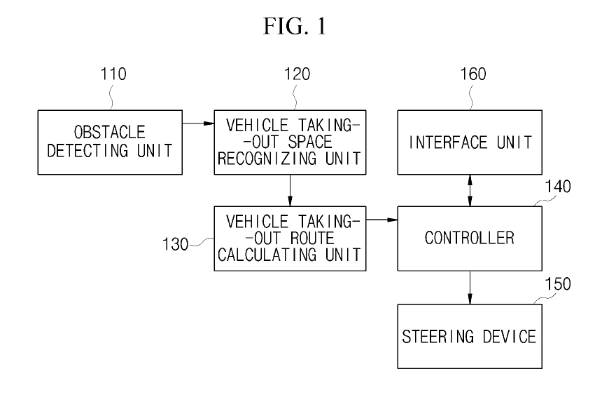

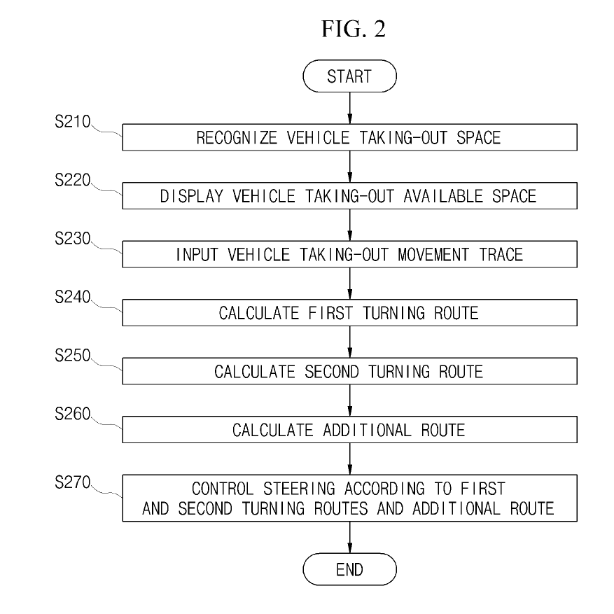

FIG. 1 is a block diagram for describing a configuration of an apparatus for controlling automatic taking-out of a vehicle according to an exemplary embodiment of the present invention, and FIG. 2 is a flowchart for describing a method of controlling automatic taking-out of a vehicle according to an exemplary embodiment of the present invention.

Referring to FIG. 1, an apparatus for controlling automatic taking-out of a vehicle according to an exemplary embodiment of the present invention includes an obstacle detecting unit 110, a vehicle taking-out space recognizing unit 120, a vehicle taking-out route calculating unit 130, a controller 140, a steering device 150, and an interface unit 160.

The obstacle detecting unit 110 detects obstacles at front and rear sides of the vehicle and a curb at a lateral side of the vehicle, and the vehicle taking-out space recognizing unit 120 recognizes a vehicle taking-out space. The obstacle detecting unit 110 is a detecting means mounted in the vehicle to measure a distance to an obstacle and generate an electric signal corresponding to the distance, and may be implemented by an ultrasonic sensor, and the like.

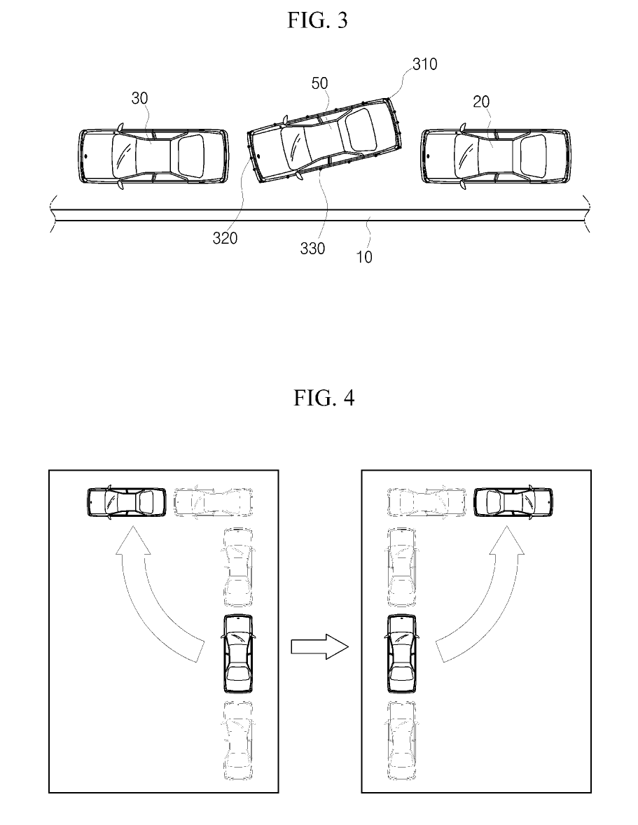

The vehicle taking-out space recognizing unit 120 measures distance values from a front obstacle detecting unit 310 to a front obstacle 20, and measures a relative first position value between the front obstacle 20 and a corresponding vehicle 50 as illustrated in FIG. 3.

The vehicle taking-out space recognizing unit 120 measures distance values from a rear obstacle detecting unit 320 to a rear obstacle 30, and measures a relative second position value between the rear obstacle 30 and the corresponding vehicle 50.

The vehicle taking-out space recognizing unit 120 measures distance values from a lateral obstacle detecting unit 330 to a curb 10, and measures a third position value between the curb 10 and the corresponding vehicle 50 to recognize a vehicle taking-out space.

The vehicle taking-out route calculating unit 130 calculates a relative position of a corner PL of a front obstacle calculated by the vehicle taking-out space recognizing unit 120, and a first turning route, a second turning route, and an additional route for parallelly taking out the vehicle based on a user input as illustrated in FIG. 3.

In this case, the vehicle taking-out route calculating unit 130 calculates a vehicle taking-out start position P0, first and second stop positions P1 and P2, and a vehicle taking-out end position Pe for each turning route when calculating the first turning route, the second turning route, and the additional route.

Hereinafter, the calculation of the turning route for parallelly taking out the vehicle will be described in more detail.

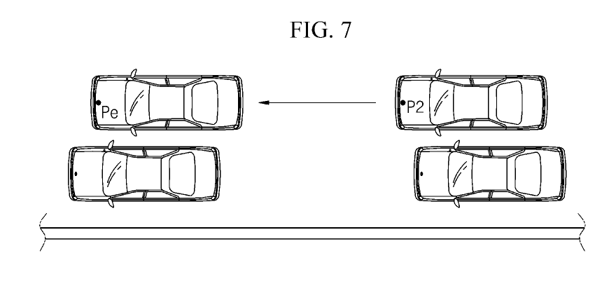

First, as illustrated in FIG. 5, the vehicle taking-out route calculating unit 130 calculates a first turning angle θ1 and a vehicle taking-out start position P0 satisfying a collision avoidance condition with respect to a corner PL of the front obstacle when maximally steering the vehicle, and calculates a first stop position P1, at which the vehicle may move to a vehicle taking-out end position with the shortest distance to calculate a first turning route.

Next, as illustrated in FIG. 6, the vehicle taking-out route calculating unit 130 calculates a second turning angle θ and a second stop position P2 satisfying a condition that one side end of a center line of a rear wheel and a y-axis of the corner PL of the front obstacle when the vehicle turns forwardly from the calculated first stop position P1 to calculate a second turning route. Here, when the vehicle stops at the point, at which one side end of the center line of the rear wheel meets the y-axis of the corner PL of the front obstacle, there is no danger of collision of the vehicle with the corner PL of the front obstacle at the second turning route.

Next, as illustrated in FIG. 7, the vehicle taking-out route calculating unit 130 calculates an additional path from the second stop position P2 to a vehicle taking-out end position Pe, at which the touch of the user input is ended, based on the user input.

The controller 140 provides a steering control signal to the steering device 150 according to the first turning route, the second turning route, and the additional route calculated by the vehicle taking-out route calculating unit 130 to perform steering control.

Particularly, the controller 140 first controls steering according to the first turning route, in which the vehicle forwardly turns from the vehicle taking-out start position P0 to the first stop position P1 at the first turning angle θ1.

Next, the controller 140 controls steering according to the second turning route, in which the vehicle forwardly turns from the first stop position P1 to the second stop position P2 at the second turning angle θ2.

The controller 140 controls steering according to the additional route, in which the vehicle reverses from the second stop position P2 to the vehicle taking-out end position Pe.

As described above, the controller 140 controls the steering device 150 based on the first turning route, the second turning route, and the additional route to perform steering control for parallelly taking out the vehicle.

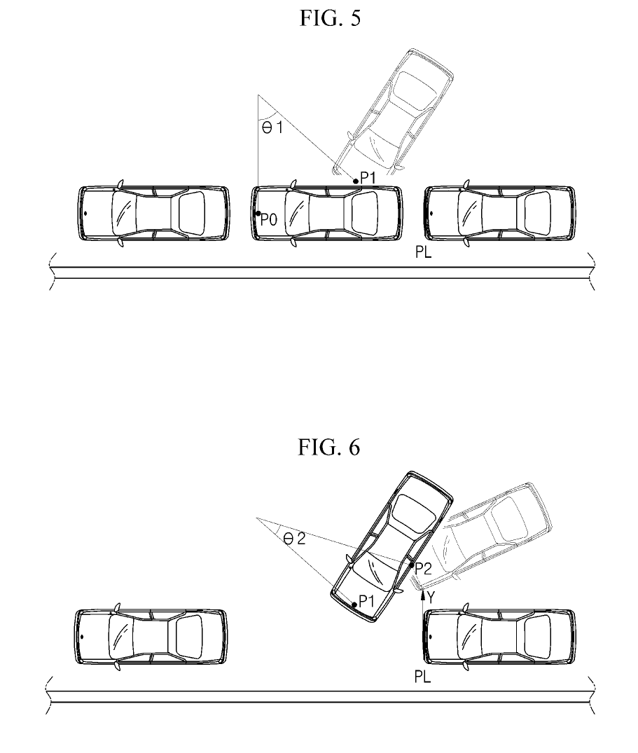

In the meantime, as illustrated in FIG. 4, the controller 140 may display performance of parallelly taking out the vehicle through the interface unit 160, and control turn-on of an emergency light, which means that parallelly taking out the vehicle is being performed, for safe parallel taking-out of the vehicle.

The controller 140 may control the interface unit 160 so as to display an image of the recognized vehicle taking-out space, and display a relative position relation between the front and rear obstacles and the curb at the lateral side of the vehicle and the driver's vehicle as an image. Here, the interface unit 160 may include a display device, an audio output unit, an emergency light, and a touch panel.

Accordingly, the interface unit 160 may receive a touch input for a vehicle taking-out movement trace desired by a user from the user.

A method of controlling automatic taking-out of a vehicle according to an exemplary embodiment of the present invention corresponding to the operation of the apparatus for controlling automatic taking-out of a vehicle of the present invention including the aforementioned configuration will be described in stages.

First, referring to FIG. 2, a vehicle taking-out space is recognized by detecting a distance from a vehicle taking-out start position P0, at which a vehicle is parked, to obstacles positioned at front and rear sides of the vehicle and a curb positioned at a lateral side of the vehicle (S210).

That is, the vehicle taking-out space may be recognized by measuring distance values with a front obstacle and measuring a relative first position value between the front obstacle and the corresponding vehicle, measuring distance values with a rear obstacle and measuring a relative second position value between the rear obstacle and the corresponding vehicle, and measuring distance values with a curb and measuring a relative third position value between the curb and the corresponding vehicle. Further, the detection of the obstacle may use an ultrasonic sensor, and the like as a detecting means mounted in the vehicle to measure a distance to an obstacle and generate an electric signal corresponding to the distance.

Then, the recognized vehicle taking-out space and information about the obstacles positioned at front and rear sides of a position, at which the vehicle is currently parked, and the curb positioned at the lateral side of the position are displayed through the interface unit (S220).

Next, a movement trace for parallelly taking out the vehicle is received from a user through the interface unit (S230).

Next, a first turning route, a second turning route, and an additional route are calculated based on the vehicle taking-out space recognized in operation S210 and the user's input of the movement trace (S240, S250, and S260).

Operations S240, S250, and S260 will be described in more detail. First, as illustrated in FIG. 5, the vehicle taking-out route calculating unit 130 calculates a first turning angle θ1 and a vehicle taking-out start position P0 satisfying a collision avoidance condition with respect to a corner PL of the front obstacle when maximally steering the vehicle, and calculates a first stop position P1, from which the vehicle may move to a vehicle taking-out end position with the shortest distance to calculate a first turning route.

Next, as illustrated in FIG. 6, the vehicle taking-out route calculating unit 130 calculates a second turning angle θ and a second stop position P2 satisfying a condition that one side end of a center line of a rear wheel and a y-axis of the corner PL of the front obstacle when the vehicle turns forwardly from the calculated first stop position P1 to calculate a second turning route. Here, when the vehicle stops at the point, at which one side end of the center line of the rear wheel meets the y-axis of the corner PL of the front obstacle, there is no danger of collision of the vehicle with the corner PL of the front obstacle at the second turning route.

Next, as illustrated in FIG. 7, the vehicle taking-out route calculating unit 130 calculates an additional path from the second stop position P2 to a vehicle taking-out end position Pe, at which the touch of the user input is ended, based on the user input.

Steering is controlled in an order of the calculated first turning route, second turning route, and additional route (S270). That is, the steering is controlled based on the first turning route in which the vehicle forwardly turns from the vehicle taking-out start position P0 to the first stop position P1 at the first turning angle θ1.

After the steering is controlled according to the first turning route, the steering is controlled based on the second turning route in which the vehicle forwardly turns from the first stop position P1 to the second stop position P2 at the second turning angle θ2.

After the steering is controlled according to the second turning route, the steering is performed so that the vehicle reverses from the second stop position P2 to the vehicle taking-out end position Pe based on the vehicle taking-out movement trace input by the user.

The present invention has been described with reference to the exemplary embodiment illustrated in the drawing, but the exemplary embodiment is only illustrative, and it would be appreciated by those skilled in the art that various modifications and equivalent exemplary embodiments may be made. Accordingly, the true technical scope of the present invention shall be defined by the accompanying claims.

According to the present invention, it is possible to decrease a vehicle taking-out time by simplifying parallel vehicle taking-out through two turning routes, decrease a vehicle taking-out time by simplifying a route for parallel vehicle taking-out, and decrease a load related to an ECU and steering.

According to the present invention, even though a route error is generated while travelling, when an x-coordinate condition of the start point and a second turning start point is satisfied, a collision with an obstacle is not generated, so that it is possible to safely park a vehicle.

According to the present invention, a vehicle taking-out route appropriate to a vehicle taking-out space is generated to control steering for parallel vehicle taking-out, so that it is possible to take out a vehicle from a narrow space, thereby improving convenience for a user.

It is possible to calculate a vehicle taking-out movement trace through a drag-and-drop touch input of a user using a touch pad, thereby improving convenience for a user.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for controlling automatic taking-out of a vehicle, the apparatus comprising:
a vehicle taking-out space recognizing unit configured to detect obstacles at front and rear sides of a vehicle and a curb at a lateral side of the vehicle to recognize a vehicle taking-out space;
an interface unit configured to display the recognized vehicle taking-out space, the recognized obstacles at the front and rear sides of the vehicle, and the vehicle as images, and receive a vehicle taking-out movement trace from a user;
a vehicle taking-out route calculating unit configured to sequentially calculate turning routes for parallelly taking out the vehicle based on the recognized vehicle taking-out space and the user input; and
a controller configured to control steering for parallelly taking out the vehicle according to the calculated sequential turning routes.

2. The apparatus of claim 1, wherein the vehicle taking-out space recognizing unit measures distance values with the front obstacle to measure a relative first position value with respect to the front obstacle, measures distance values with the rear obstacle to measure a relative second position value with respect to the rear obstacle, and measures distance values with the curb to measure a relative third position value with respect to the curb.

3. The apparatus of claim 1, wherein the vehicle taking-out route calculating unit calculates a first turning route, a second turning route, and an additional route for parallelly taking out the vehicle based on a relative position with respect to a corner of the front obstacle recognized by the vehicle taking-out space recognizing unit and a user input.

4. The apparatus of claim 3, wherein the vehicle taking-out route calculating unit calculates a vehicle taking-out start position for each turning route and a first stop position, from which the vehicle moves to a vehicle taking-out end position based on the user input within the shortest distance when calculating each of the first turning route, the second turning route, and the additional route.

5. The apparatus of claim 3, wherein the vehicle taking-out route calculating unit calculates a second stop position satisfying a condition that one side end of a center line of a rear wheel of the vehicle meets a y-axis of a corner of the front obstacle.

6. The apparatus of claim 3, wherein the vehicle taking-out route calculating unit calculates the additional route from the second stop position to a vehicle taking-out end position, at which a touch of the user input is ended, based on the user input.

7. The apparatus of claim 1, wherein the vehicle taking-out route calculating unit calculates a first turning angle, a vehicle taking-out start position, and a first stop position satisfying a collision avoidance condition with respect to a corner of the front obstacle while maximally steering the vehicle to calculate a first turning route, and calculates a second turning angle and a second stop position satisfying a condition that one side end of a center line of a rear wheel of the vehicle meets a y-axis of a corner of the front obstacle to calculate a second turning route.

8. The apparatus of claim 1, wherein the controller controls state information about parallel taking-out of the vehicle to be output through the interface unit through at least one manner of a video, audio, and a character.

9. A method of controlling automatic taking-out of a vehicle, the method comprising:
detecting obstacles at front and rear sides of a vehicle and a curb at a lateral side of the vehicle to recognize a vehicle taking-out space;
displaying the recognized vehicle taking-out space, the recognized obstacles at the front and rear sides of the vehicle, and the vehicle as images, and receiving a vehicle taking-out movement trace from a user;
sequentially calculating turning routes for parallelly taking out the vehicle based on the recognized vehicle taking-out space and the user input; and
controlling steering for parallelly taking out the vehicle according to the calculated sequential turning routes.

10. The method of claim 9, wherein the recognizing of the vehicle taking-out space includes:
measuring distance values with the front obstacle to measure a relative first position value with respect to the front obstacle;
measuring distance values with the rear obstacle to measure a relative second position value with respect to the rear obstacle; and
measuring distance values with the curb to measure a relative third position value with respect to the curb.

11. The method of claim 9, wherein the calculating of the turning routes includes:
calculating a first turning angle, a vehicle taking-out start position, and a first stop position satisfying a collision avoidance condition with respect to a corner of the front obstacle while maximally steering the vehicle to calculate a first turning route; and
calculating a second turning angle and a second stop position satisfying a condition that one side end of a center line of a rear wheel of the vehicle meets a y-axis of a corner of the front obstacle to calculate a second turning route.

12. The method of claim 11, wherein the calculating of the turning routes further includes calculating the additional route from the second stop position to a vehicle taking-out end position, at which a touch of the user input is ended, based on the user input.

13. The method of claim 11, wherein the controlling of the steering includes:
forwardly turning, by the vehicle, from the vehicle taking-out start position to the first stop position at the first turning angle according to the first turning route;
forwardly turning, by the vehicle, from the first stop position to the second stop position at the second turning angle according to the second turning route; and
reversing, by the vehicle, from the second stop position to the vehicle taking-out end position according to the additional route.

14. The method of claim 9, further comprising outputting state information about parallel taking-out of the vehicle to an output device by at least one manner of a video, an audio, and a character while parallelly taking out the vehicle.
